(19) United States
(12) Patent Application Publication
(10) Pub. No.: US 2010/0188605 A1
(43) Pub. Date: Jul. 29, 2010

(54) LIQUID CRYSTAL DISPLAY DEVICE AND POLARIZATION PLATE

(76) Inventors: Masahiro Hasegawa, Osaka (JP); Akira Sakai, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/670,526

(22) PCT Filed: Mar. 31, 2008
(86) PCT No.: PCT/JP2008/056321

§ 371 Date: Jan. 25, 2010

(30) Foreign Application Priority Data
Jul. 24, 2007 (JP) 2007-192543

(51) Int. Cl. G02F 1/1335

(52) U.S. Cl. 349/62

(57) ABSTRACT

The present invention has an object to provide high-luminance liquid crystal display device and polarizer, each including a reflection and polarization sheet. The present invention is a liquid crystal display device including: a backlight system including a reflection and polarization sheet; a back polarizer; a liquid crystal cell; and a front polarizer, stacked in this order, wherein the liquid crystal display device includes a protective film that protects a back face of the back polarizer, the protective film has no retardation in a thickness direction thereof, and when the protective film is viewed in plane, an optic axis of the protective film in an in-plane direction thereof is parallel to an absorption axis of the back polarizer.

### TECHNICAL FIELD

The present invention relates to a liquid crystal display device and a polarization plate. More particularly, the present invention relates to a liquid crystal display device and a polarization plate, each of which is preferably used as a liquid crystal display device with a wide viewing angle, used in a display for personal computers, a liquid crystal TV, and the like.

### BACKGROUND ART

The liquid crystal display device is now being widely used in various information-processing display devices such as a computer and a TV. Particularly in recent years, demands for a liquid crystal display device for TVs and the like have been rapidly increasing. With an expansion of market, for such a liquid crystal display device, an improvement in display qualities and a reduction in production costs, and the like, are increasingly demanded.

Under such a circumstance, a VA (vertical alignment) liquid crystal display device is being researched and developed as a technology effective in improving display qualities. The VA liquid crystal display device aligns liquid crystals with negative dielectric anisotropy vertically between substrates facing each other, under no voltage application. According to the VA liquid crystal display device, a liquid crystal cell hardly shows birefringence and optical rotation in the front direction under no voltage application. So two polarizers are arranged on both sides of the liquid crystal cell, one on each side, in a Cross-Nicol state, and thereby the device can provide almost perfect black display under no voltage application, and as a result, a very high contrast can be provided.

An IPS (in plane switching) liquid crystal display device is also disclosed as a technology effective in improving display qualities. The IPS liquid crystal display device provides display by applying a lateral electric field to a horizontal alignment liquid crystal cell including liquid crystals between upper and lower two substrates each of which has a surface that has been provided with a horizontal alignment treatment, and thereby liquid crystal molecules turn around in a plane almost parallel to the substrates. The IPS liquid crystal display device has an advantage in that a birefringence of a liquid crystal cell hardly changes in oblique directions because display is provided by changing an angle made by liquid crystal molecules and a polarizer, with the liquid crystal molecules being kept to be almost parallel to the substrates, and so a viewing angle is wide.

In addition to the above-mentioned liquid crystal display mode, Patent Document 1 discloses a liquid crystal display device that includes a reflection and polarization sheet (polarization film with selective reflection function) in a backlight system, as a technology effective in improving display qualities. The backlight system includes a light source, a light guide plate, and optical sheets, and the like, and emits light to a liquid crystal cell that is adjacent to the backlight system. The reflection and polarization sheet is a film that transmits only one linearly-polarized light component of non-polarized light emitted from the light source and reflects the other linearly-polarized light component, in the backlight system. Such a reflection and polarization sheet is arranged as an optical sheet that is positioned closest to a liquid crystal display panel among optical sheets constituting the backlight system, which brings the following advantage. A linearly-polarized light component that is originally absorbed by a back polarizer (a polarizer arranged on a backlight side of a liquid crystal display panel) is reflected in a direction of a light source of the backlight and used again, and so a transmittance (white luminance) of the liquid crystal display panel can be improved without increasing a light amount of the light source. So now the reflection and polarization sheet is an essential member for reduction in costs of the liquid crystal display device.

A polarizer that is a uniaxially molecular-orientated PVA (polyvinyl alcohol) to which a dichroic material such as iodine is adsorbed and orientated is mentioned as a polarizer used in a liquid crystal display device. Such a polarizer has room for improvement in mechanical strength, heat resistance, and moisture resistance. So a protective film 7 having transparency is attached to both sides of a polarizer 9 with an adhesive layer 8 and the like therebetween, as shown in FIG. 10, for securing durability of the polarizer 9.

A TAC (triacetyl cellulose) film is being widely used as the protective film because of high optical transparency, excellent adhesion to a PVA that is a material for polarizers, and low costs. However, the TAC film has a retardation (Rth) in its thickness direction, and so it has no influence on display performances in the front direction, but in oblique directions, the display qualities are deteriorated due to the retardation.

In view of this, for example, Patent Document 2 discloses that in order to improve the display qualities in oblique directions, not only a retardation (Re) in the front direction but also a retardation (Rth) in the thickness direction need to be decreased. For example, Patent Documents 3 and 4 each disclose a liquid crystal display device including an isotropic film as a protective film, the isotropic film being arranged on a liquid crystal cell-side surface of protective films each adhered to a surface of a polarization film.

In addition, a reduction in costs is also needed for the liquid crystal display device. In view of this, for example, Patent Document 5 discloses a liquid crystal display device including a multi-layer protective film that is arranged on both sides of a polarization film, the multi-layer protective film being provided with functions as a retardation film, in order to reduce the number of members constituting a polarization plate and improve durability of the polarization plate. In such a liquid crystal display device, the protective film has a retardation in the in-plane direction and the thickness direction thereof.
[Patent Document 1]
Japanese Kokai Publication No. H10-247410
[Patent Document 2]
Japanese Kokai Publication No. 2006-195136
[Patent Document 3]
Japanese Kokai Publication No. H06-51120
[Patent Document 4]
Japanese Kokai Publication No. 2006-39420
[Patent Document 5]
Japanese Kokai Publication No. H08-43612

### DISCLOSURE OF INVENTION

As mentioned above, a protective film is typically attached to both sides of a polarizer that is arranged on both sides (front side and back side) of a liquid crystal cell. The protective films that are not arranged between the two polarizers, i.e., the two protective films on the side opposite to the liquid crystal cell side have been considered to have no influences on display performances, and these protective films have been not especially limited. So a TAC film has been much used as these two protective films because of high optical transparency, excellent adhesion to a PVA, and low price. However, for example, there is still room for improvement in that, if a backlight system includes a reflection and polarization sheet in order to improve a transmittance of a liquid crystal panel, linearly-polarized light obtained by the reflection and polarization sheet is converted into different polarization state due to a retardation in the thickness direction of the TAO film, and so an effect of improvement in white luminance contributed to the reflection and polarization sheet is insufficiently exhibited. There is also room for improvement in that, if a protective film is provided with functions of a retardation film, for example, in order to reduce the number of members constituting a polarization plate, linearly-polarized light obtained by the reflection and polarization sheet is converted into different polarization state due to a retardation of the protective film, and so an effect of improvement in white luminance contributed to the reflection and polarization sheet is insufficiently exhibited.

The present invention has been made in view of the above-mentioned state of the art. The present invention has an object to provide a high-luminance liquid crystal display device and a polarization plate, including a reflection and polarization sheet.

The present inventors made various investigations of a liquid crystal display device including a backlight system having a reflection and polarization sheet, a back polarizer, a liquid crystal cell, and a front polarizer, stacked in this order. The inventors noted a film member that is arranged between the reflection and polarization sheet and the back polarizer, particularly a protective film for protecting a back face of the back polarizer. For example, a liquid crystal display device shown in FIG. 11 is configured to include a backlight system 5 and a liquid crystal display panel 6, the backlight system 5 being composed of CCFLs (cold cathode fluorescent lamps) 1, a diffusion plate 2, a diffusion sheet 3, and a reflection and polarization sheet 4, stacked in this order from the back face side (backlight side) to the front face side, the liquid crystal display panel 6 being composed of a liquid crystal cell 12 to one side of which a front polarization plate (observation-side polarization plate) 14 is attached and to the other side of which a back polarization plate (backlight-side polarization plate) 11 is attached, each polarization plate being attached to the cell 12 with an adhesive 10 therebetween. The front polarization plate 14 is composed of a TAC protective film 7, an adhesive layer 8, a front polarizer 9a including a PVA film as a base, another adhesive layer 8, and another TAC protective film 7, stacked in this order from the front face side to the back face side. The back polarization plate 11 is composed of a protective film 13 having functions of a retardation film, an adhesion layer 8, a back polarizer 9b, another adhesion layer 8, and a TAC protective film 7, stacked in this order from the front face side to back face side. Thus, in the liquid crystal display device shown in FIG. 11, the TAC protective film 7 is disposed between the reflection and polarization sheet 4 and the back polarizer 9b.

FIG. 12 is a schematic view showing a refractive index distribution of the TAC protective film 7 in FIG. 11. As shown in FIG. 12, the TAC protective film 7 is a negative C-plate satisfying a condition of nx=ny>nz, with two principal refractive indexes in the in-plane direction being nx, ny, one principal refractive index in the normal direction being nz, of three principal refractive indexes of a indicatrix.

FIG. 13 is a schematic view showing, in the liquid crystal display device shown in FIG. 11, an absorption axis a and a transmission axis t of the back polarizer 9b, an axis angle of a refractive index distribution of the TAC protective film 7, and a reflection axis R and a transmission axis T of the reflection and polarization sheet 4, when the device is viewed in a direction of light propagation. FIG. 13(a) shows those when an incident direction of light is the front direction (plan view or front view). FIG. 13(b) shows those when an incident direction of light is a direction with an angle half of an angle made by the absorption axis and the transmission axis of the back polarizer with respect to the front direction (oblique view).

The TAC protective film 7 has a refractive index difference shown in FIG. 13(b) when viewed in an oblique direction. The transmission axis T of the reflection and polarization sheet 4 and the transmission axis t of the back polarizer 9b are not parallel to each axis (phase advance axis f and phase delay axis s) of principal refractive indexes of the TAC protective film 7. Accordingly, light that enters the reflection and polarization sheet 4 in an oblique direction from the light source 1 is converted into linearly-polarized light that oscillating in the transmission axis T-direction by the sheet 4, and then, converted into elliptically-polarized light by the film 7, and then, a part of the light is absorbed by the back polarizer 9b. As a result, the transmittance in the oblique direction of the liquid crystal display device is reduced, which leads to a reduction in white luminance in the oblique direction.

The present inventors noted that the retardation (Rth) in the thickness direction of the TAC protective film 7 directly causes a reduction in white luminance in the oblique direction. The inventors found that the white luminance in the oblique direction can be improved in the following case. An optical film (isotropic film) that has no retardation in its thickness direction and that shows optical isotropy is used as a protective film for protecting a back face of a back polarizer, and thereby a transmission axis of a reflection and transmission sheet and a transmission axis of a back polarizer are parallel to each axis of principal refractive indexes of the protective film regardless of observation direction. As a result, linearly-polarized light obtained by the reflection and polarization sheet is suppressed from being converted into different polarization state by the protective film and further a linearly-polarized light component can be suppressed from being absorbed by the back polarizer. A part of white luminance improved in the oblique direction is emitted also in the front direction by scattering by a member a liquid crystal display panel includes and by being scattered by an AG (anti-glare) treated uneven surface of the panel and by particles included inside the surface. As a result, the white luminance in the front direction can be also improved.

The present inventors also made investigations of the case where an optical film that has a retardation in its in-plane direction is used as the protective film for protecting the back face of the back polarizer. The inventors found that if the protective film has no retardation in its thickness direction, the same advantages as in use of the isotropic film can be obtained by arranging the protective film in such a way that an optic axis in the in-plane direction of the protective film is parallel to an absorption axis of the back polarizer when the protective film is viewed in plane. Thus, the inventors found that if in a liquid crystal display device including a backlight system having a reflection and polarization sheet, a protective film that protects a back face of a back polarizer has no retardation in the thickness direction and such a film is arranged in such a way that its optic axis (the direction where two normal velocities are the same) in the in-plane direction is parallel to the absorption axis of the back polarizer, the white luminance in the front and oblique directions can be improved regardless of whether or not a protective film has a retardation in its in-plane direction. As a result, the above-mentioned problems have been admirably solved, leading to completion of the present invention.

That is, the present invention is a liquid crystal display device including:

a backlight system including a reflection and polarization sheet;

a back polarizer;

a liquid crystal cell; and

a front polarizer, stacked in this order,

wherein the liquid crystal display device includes a protective film that protects a back face of the back polarizer,

the protective film has no retardation in a thickness direction thereof, and

when the protective film is viewed in plane,

an optic axis of the protective film in an in-plane direction thereof is parallel to an absorption axis of the back polarizer (hereinafter, also referred to as a “first liquid crystal display device”).

The present invention is mentioned below in more detail.

The first liquid crystal display device of the present invention includes a backlight system having a reflection and polarization sheet, a back polarizer, a liquid crystal cell, and a front polarizer, stacked in this order. The “reflection and polarization sheet” used herein is also referred to as a polarization splitting sheet, and it means a film that has a function of transmitting a part of a polarized light component of non-polarized light (natural light) emitted from a light source of the backlight system and reflecting the other polarized light components of the non-polarized light. The backlight system is provided with the reflection and polarization sheet, and thereby a polarized light component that is originally absorbed by the back polarizer is reflected to a direction of the light source of the backlight, and used it again. As a result, the white luminance can be improved without increasing a light amount of the light source. In order to obtain linearly-polarized light by the reflection and polarization sheet, the following ways are mentioned.
(1) non-polarized light is split into a reflection component and a transmission component in accordance with axis directions perpendicular to each other; and
(2) non-polarized light is split into a reflection component and a transmission component in accordance with right-hand and left-hand circular polarizations by the reflection and polarization sheet, and the transmitted circularly-polarized light is converted into linearly-polarized light by a ¼ wavelength plate.

The way (1) is specifically mentioned below, for example. As shown in FIG. 14(a), a linearly-polarized light component 22 that oscillates in one direction, of light incident on a reflection and polarization sheet 24a, is transmitted, and a linearly-polarized light component 23 that oscillates in a direction perpendicular to the oscillation direction of the component 22 is reflected and used again. In this case, the oscillation direction of the component 22 is referred to as a transmission axis of the reflection and polarization sheet 24a, and the oscillation direction of the component 23 is referred to as a reflection axis of the reflection and polarization sheet 24a. In the way (1), the reflection and polarization sheet is typically arranged in such a way that its reflection axis is parallel to an absorption axis of the back polarizer when the sheet is viewed in plane. The way (2) is specifically mentioned below, for example. As shown in FIG. 14(b), a right-handed circularly-polarized light component 26 of light incident on a reflection and polarization sheet 24b is transmitted, and the transmitted right-handed circularly-polarized light component 26 is converted into linearly-polarized light 28 by a ¼ wavelength plate 25, and simultaneously a left-handed circularly-polarized light component 27 is reflected and used again. In the way (2), the ¼ wavelength plate is typically arranged in such a way that its axis makes an angle of 45° with an absorption axis of the back polarizer. The “backlight system” used herein is a device that projects light from the back face of the liquid crystal cell and that includes at least light sources such as a CCFL, and various optical films (sheets) that control light emitted from the light sources. The structure of backlight system is not especially limited, and a direct type (structure where the light sources are arranged just below the display face), an edge light type (structure where the light sources are arranged on the side of a display face), a planar light source-type, and the like, may be used. The “polarizer” used herein is an element that can convert natural light into linearly-polarized light. The polarizer absorbs most polarized light components other than a transmission polarized light component. The reflection and polarization sheet reflects most polarized light components other than the transmission polarized light component. In such a point, the two are different. The “liquid crystal cell” used herein is an optical element that electrically controls a transmitted or reflected light amount and has a structure where liquid crystals are imposed between two substrates facing each other.

The first liquid crystal display device includes a protective film that protects a back face of the back polarizer. The protective film has no retardation in the thickness direction thereof and its optic axis in the in-plane direction thereof is parallel to an absorption axis of the back polarizer when viewed in plane. The “optic axis” used herein is a direction where two normal velocities show the same value (no birefringence is observed). Accordingly, the protective film that protects the back face of the back polarizer has no retardation in the thickness direction and the protective film is arranged in such a way that its optic axis in the in-plane direction is parallel to the absorption axis of the back polarizer when viewed in plane, and thereby a transmission axis of the back polarizer can be parallel to axes of principal refractive indexes of the protective film regardless of the observation direction. So linearly-polarized light obtained by the reflection and polarization sheet alone or a combination of the reflection and polarization sheet and the ¼ wavelength plate can pass through the protective film without being converted into different polarization state even when the light enters the protective film from an oblique direction. So the linearly-polarized light component can be suppressed from being absorbed by the back polarizer. As a result, the white luminance in an oblique direction of the liquid crystal display device can be improved. A part of the white luminance that is improved in the oblique direction is emitted also in the front direction by being scattered by a component the liquid crystal display panel includes and by an AG (anti-glare)-treated uneven surface of the panel and by particles included inside the surface. As a result, the white luminance in the front direction of the liquid crystal display device can be also improved.

In the present description, the expression “has no retardation in its thickness direction in the thickness direction thereof)” means that not only perfectly no retardation is shown in its thickness direction but also substantially no retardation is shown in its thickness direction, i.e., the retardation may be shown in its thickness direction unless display qualities are influenced by the retardation. Specifically, the protective film preferably has a retardation Rth [590] in its thickness direction of 10 nm or less at a wavelength of 590 nm, and more preferably 8 nm or less, and still more preferably 5 nm or less.

The protective film has an optic axis in its in-plane direction. The number of the optic axis in the in-plane direction may be one or two or more for one protective film. The structure of the protective film is not especially limited, and it may be a single-layer or multi-layer structure.

In order to protect the back face of the back polarizer, the following materials are mentioned as a material for the protective film. A polycarbonate resin, a polyethylene resin, a cellulose resins, a norbornene resin, a methacrylic resin, a styrene resins, and an N-phenyl-substituted maleimide resin may be used singly or in mixture. From the same view point, it is preferable that the protective film has a thickness of 10 to 100 μm. The absorption rate of the protective film is preferably 10% or less. The protective film is typically attached to the back face of the back polarizer with an adhesive or cohesive material therebetween.

The term “parallel” used herein means not only “perfectly parallel” but also “substantially parallel”, i.e., the axes may not be necessarily perfectly parallel unless display qualities are influenced. Specifically, an angle made by the absorption axis of the back polarizer and the optic axis of the protective film is preferably 1° or less and more preferably 0.3° or less. As a result, the rate of conversion into elliptically-polarized light is decreased, which can suppress the reduction in white luminance.

The first liquid crystal display device of the present invention is not especially limited, and it may or may not include other members, as long as it includes the backlight system having the above-mentioned reflection and polarization sheet, the protective film for protecting the back face of the back polarizer, the back polarizer, the liquid crystal cell, and the front polarizer as members. The first liquid crystal display device also includes a protective film for protecting a front face of the back polarizer, in addition to the protective film for protecting the back face of the back polarizer, in order to protect the back polarizer, and also includes protective films for protecting front and back faces of the front polarizer in order to protect the front polarizer. The liquid crystal display mode of the first liquid crystal display device of the present invention is not especially limited, and it may be VA mode (vertical alignment), IPS (in-plane switching) mode, twisted nematic (TN) mode, optically compensated bend (OCB) mode, and the like.

Preferable embodiments of the first liquid crystal display device of the present invention are mentioned in more detail below.

It is preferable that the protective film is an optical film that shows optical isotropy, i.e., an isotropic film. The isotropic film has no retardation in its thickness direction, unlike the TAC film, and the like. The isotropic film has infinite optic axes in its in-plane direction, and so the optic axes of the isotropic film in the in-plane direction are parallel to the transmission axis of the back polarizer regardless of the observation direction. Accordingly, attributed to the use of the isotropic film as the protective film, the advantages of the present invention can be obtained. In the present description, the expression “shows optical isotropy” means that not only “shows strict optical isotropy” but also that “shows substantially optical isotropy”, i.e., the film may not necessarily show strict optical isotropy unless display qualities are influenced. Specifically, each of a retardation Re [590] in the in-plane direction and a retardation Rth [590] in the thickness direction is preferably 10 nm or less, more preferably 8 nm or less, and still more preferably 5 nm or less, at a wavelength of 590 nm.

It is preferable that the protective film is an optical film that has a retardation in the in-plane direction thereof and shows optically positive uniaxial, i.e., a positive A plate, and

when the protective film is viewed in plane,

a phase delay axis of the protective film in the in-plane direction thereof is parallel to the absorption axis of the back polarizer. The positive A-plate also has no retardation in its thickness direction, unlike the TAC film and the like. According to the positive A-plate, its phase delay axis is an optic axis in the in-plane direction. Accordingly, by arranging the positive A-plate as the protective film in such a way that its phase delay axis in the in-plane direction is parallel to the absorption axis of the back polarizer when the plate is viewed in plane, a transmission axis of the back polarizer can be parallel to a phase advance axis of the protective film regardless of the observation direction. As a result, the advantages of the present invention can be obtained. The positive A-plate can be formed from a single material, and so it can be produced easily and at low costs, unlike the isotropic film. Further, compared with a negative A-plate, the positive A-plate can be formed from many kinds of materials, and so the materials for the positive A-plate is easy to obtain. In the present description, the expression “shows optically positive uniaxial” means not only “shows strictly optically positive uniaxial” but also “shows substantially optically positive uniaxial”, i.e., the protective film may not necessarily show strictly optically positive uniaxial unless display qualities are influenced. Specifically, a retardation Ryz [590] is preferably 10 nm or less, and more preferably 8 nm or less, and still more preferably 5 nm or less, at a wavelength of 590 nm.

It is preferable that the protective film is an optical film that has a retardation in the in-plane direction thereof and shows optically negative uniaxial, i.e., a negative A-plate, and

when the protective film is viewed in plane,

a phase advance axis of the protective film in the in-plane direction thereof is parallel to the absorption axis of the back polarizer. The negative A-plate also has no retardation in its thickness direction, unlike the TAC film, and the like. According to the negative A-plate, phase advance axis is an optic axis. Accordingly, by arranging the negative A-plate as the protective film in such a way that its phase advance axis in the in-plane direction is parallel to the absorption axis of the back polarizer when the plate is viewed in plane, a transmission axis of the back polarizer can be parallel to a phase delay axis of the protective film regardless of the observation direction. As a result, the advantages of the present invention can be obtained. The negative A-plate can be formed from a single material, and so it can be produced easily and at low costs, unlike the isotropic film. In the present description, the expression “shows optically negative uniaxial” means not only “show strictly optically negative uniaxial” but also “shows substantially optically negative uniaxial”, i.e., the protective film may not necessarily show strictly optically negative uniaxial unless display qualities are influenced. Specifically, a retardation Ryz [590] is preferably 10 nm or less, and more preferably 8 nm or less, and still more preferably 5 nm or less, at a wavelength of 590 nm.

The present invention is also a polarization plate including:

a reflection and polarization sheet;

a first protective film;

a polarizer; and

a second protective film, stacked in this order,

wherein the first protective film has no retardation in a thickness direction thereof, and

when the first protective film is viewed in plane,

an optic axis of the first protective film in the in-plane direction thereof is parallel to an absorption axis of the polarizer. According to the first liquid crystal display device of the present invention, the reflection and polarization sheet is a member of the backlight system, but according to the polarization plate of the present invention, the reflection and polarization sheet is a member of the polarization plate. Accordingly, in a liquid crystal display device that provides display using light sources such as a backlight, the polarization plate of the present invention is arranged on a back side of a liquid crystal cell in such a way that the reflection and polarization sheet is positioned on the back face side of the polarization plate and the second protective film is positioned on the liquid crystal cell side thereof, and thereby, the same advantages as in the first liquid crystal display device of the present invention can be obtained.

The polarization plate of the present invention is not especially limited and it may or may not include other members as long as it includes the above-mentioned reflection and polarization sheet, the first protective film, the polarizer, and the second protective film as members. According to the polarization plate of the present invention, the above-mentioned reflection and polarization sheet is typically attached to a back face of the first protective film with an adhesive or cohesive material therebetween. The material for the first and second protective films, and the like, are the same as those of the protective film in the first liquid crystal display device of the present invention.

The following embodiments are mentioned as preferable embodiments of the polarization plate of the present invention.
(1) an embodiment in which the first protective film is an optical film that shows optical isotropy.
(2) an embodiment in which the first protective film is an optical film that has a retardation in the in-plane direction thereof and shows optically positive uniaxial, and

when the first protective film is viewed in plane,

a phase delay axis of the protective film in the in-plane direction thereof is parallel to the absorption axis of the polarizer.
(3) an embodiment in which the first protective film is an optical film that has a retardation in the in-plane direction thereof and shows optically negative uniaxial, and

when the first protective film is viewed in plane,

a phase advance axis of the protective film in the in-plane direction thereof is parallel to the absorption axis of the polarizer.

According to embodiments (1) to (3), the same advantages as in the corresponding preferable embodiments of the first liquid crystal display device of the present invention can be obtained.

The present invention is further a liquid crystal display device including:

a backlight system;

the above-mentioned polarization plate;

a liquid crystal cell; and

a front polarizer, stacked in this order,

wherein the reflection and polarization sheet is arranged on a side of the backlight system, and

the second protective film is arranged on a side of the liquid crystal cell (hereinafter, also referred to as a “second liquid crystal display device”). The second liquid crystal display device of the present invention has a configuration similarly to that of the first liquid crystal display device of the present invention, and therefore it can exhibit the same advantages as those of the first liquid crystal display device of the present invention. The liquid crystal display mode of the second liquid crystal display device of the present invention is not especially limited, and it may be VA mode (vertical alignment), IPS (in-plane switching) mode, twisted nematic (TN) mode, optically compensated bend (OCB) mode, and the like.

### Effect of the Invention

According to the liquid crystal display device of the present invention, it is possible to suppress linearly-polarized light obtained by the reflection and polarization sheet from being converted into different polarization state by the protective film for protecting the back face of the back polarizer, and so absorption of the linearly-polarized light component by the back polarizer can be suppressed. As a result, the white luminance in an oblique direction can be improved, and further, a part of the white luminance that is improved in the oblique direction is emitted also in the from direction by being scattering by a member a liquid crystal display panel includes and by an AG (anti-glare)-treated uneven surface of the panel and by particles included inside the surface. Thus, a liquid crystal display device with high luminance and excellent display qualities can be provided.

### BEST MODES FOR CARRYING OUT THE INVENTION

The present invention is mentioned in more detail below with reference to Embodiments and Examples, but not limited thereto.

### Embodiment 1

FIG. 1 is a cross-sectional view schematically showing a configuration of a liquid crystal display device in accordance with Embodiment 1.

The liquid crystal display device of the present Embodiment is composed of a backlight system 5 and a liquid crystal display panel 15, as shown in FIG. 1. The backlight system 5 is composed of cold-cathode fluorescent tubes (light sources) 1, a diffusion plate 2 (optical member capable of diffusing a light beam by a scattering factor included thereinside), a diffusion sheet 3 (optical member capable of diffusing a light beam by its surface roughness), and a reflection and polarization sheet 4, stacked in this order from the back face side to the front surface side. The liquid crystal display panel 15 is composed of a front polarization plate 19 (observation-side polarization plate) and a back polarization plate 20 (backlight-side polarization plate) that are attached to surfaces of a liquid crystal cell 12 with a cohesive material 10 therebetween, respectively. The front polarization plate 19 is composed of a fourth protective film 18, an adhesive material 8, a front polarizer 9a, another adhesive material 8, and a third protective film 17, stacked in this order from the front face side to the back face side. The back polarization plate 20 is composed of a second protective film 21, an adhesive material 8, a back polarizer 9b, another adhesive material 8, and a first protective film 16 (protective film, a protective film for protecting the back face of the back polarizer), stacked in this order from the front face side to the back face side.

### Reflection and Polarization Sheet

As the reflection and polarization sheet 4, a member that can provide linearly-polarized light by splitting non-polarized light (natural light) into a reflection component and a transmission component in accordance with axis directions perpendicular to each other is mentioned. Examples of such a member include: a grid polarizer; a multi-layer thin film composed of two or more stacked layers formed from two or more materials with refractive index difference; a deposited multi-layer thin film different in refractive index, which is used in a beam splitter, and the like; a birefringent multi-layer thin film composed of two or more stacked layers formed from two or more materials with refractive indexes; and a stretched resin multi-layer film composed of two or more stacked layers formed from two or more resins with refractive indexes. For example, a material prepared by uniaxially stretching a multi-layer film that is alternate layers composed of a material that exhibits much retardation by the stretch (for example, a polyethylene resin, a polycarbonate resin, or an acrylic resin), and a material that hardly exhibits retardation by stretching (for example, a norbornene resin) can be used. As such a reflection and polarization sheet 4, a luminance-increasing film (trade name: DBEF (dual brightness enhancement film), product of Sumitomo 3M Limited) may be mentioned as a typical one.

In addition, the reflection and polarization sheet 4 may be, for example, a member that is prepared by stacking a ¼ wavelength plate on one or more cholesteric liquid crystal layers and splitting natural light into a reflection component and a transmission component in accordance with right-hand and left-hand circular polarization and converting the transmitted circularly-polarized light into linearly-polarized light by the ¼ wavelength plate. As such a member, the following is mentioned, for example. An alignment film (for example, polyimide, polyvinyl alcohol, polyester, polyarylate, poly amide imide, polyether imide) that has been rubbed with a rayon cloth, and the like, or an alignment film such as an obliquely deposited silicon oxide (SiO₂) film, is arranged on a supporting base, and thereon or alternatively, on a supporting base with molecular orientation property, formed of a stretched film, and the like, a cholesteric liquid crystal layer in which cholesteric liquid crystals align uniformly in one direction is arranged, and further thereon, a ¼ wavelength retardation film is arranged. A luminance-increasing film (trade name: NIPOCS-PCF, product of Nitto Denko Corp.) is mentioned as a typical example of the reflection and polarization sheet.

### Fourth Protective Film

The fourth protective film 18 is not especially limited, but from view point of improvement in durability of the front polarizer 9a, it is preferable that the film 18 is excellent in heat resistance, moisture permeability, and mechanical strength. From view point of improvement in adhesion to the front polarizer 9a, it is preferable that the film 18 is excellent in surface flatness and adhesion to the adhesive material. For example, a TAO film, a polymer film formed from a norbornene resin, and the like, are mentioned. The film may or may not be provided with an AG (anti-glare) treatment, an AR (anti-reflection) or LR (low reflection) treatment, and the like.

### Third Protective Film, Second Protective Film

It is preferable that the third protective film 17 and the second protective film 21 have optically high transparency, and further the films 17 and 21 are excellent in heat resistance, moisture permeability, and mechanical strength in view of improvement in durability of the front polarizer 9a and the back polarizer 9b. Further, in view of improvement in adhesion to the front polarizer 9a and the back polarizer 9b, the films 17 and 21 are excellent in surface flatness and adhesive to the adhesive material. In view of improvement in adhesion to the liquid crystal cell 12, the films 17 and 21 are excellent in adhesion to the cohesive material 10. For example, a polymer film formed from a norbornene resin, and a TAC film are mentioned. In order to suppress uneven light leakage in black state due to temperature irregularity, it is most preferable that a polymer film formed from a norbornene resin is used. Further, it is preferable that at least one of the third protective film 17 and the second protective film 21 has functions of a retardation film for optical compensation in order to decrease the number of members constituting the polarization plate and improve durability of the polarization plate.

### First Protective Film

As the first protective film 16, an isotropic film that shows optical isotropy, an optical film (so-called A-plate) that has a retardation in its in-plane and that shows optically positive or negative uniaxial can be used. In this case, the positive A-plate is arranged in such a way that its phase delay axis is parallel to an absorption axis of a polarizer and the negative A-plate is arranged in such a way that its phase advance axis is parallel to an absorption axis of a polarizer. In this case, the term “parallel” means not only “perfectly parallel”, but also “substantially parallel”, i.e., the two axes may not be necessarily perfectly parallel to each other unless display qualities are influenced. Specifically, an angle made by the absorption axis of the back polarizer 9b and an optic axis of the positive or negative A-plate is preferably 1° or less, and more preferably 0.3° or less. As a result, the rate of conversion into elliptically-polarized light is decreased, which can suppress the reduction in white luminance.

### Use of Isotropic Film

FIG. 2 is a schematic view showing a refractive index distribution of an isotropic film.

The isotropic film means a film satisfying a condition of nx=ny=nz, with two principal refractive indexes in the in-plane direction being nx, ny, one principal refractive index in the normal direction being nz, of three principal refractive indexes of a indicatrix. The isotropic film can be prepared from a resin with negative retardation (styrene resin and the like) and a resin with positive retardation (poly carbonate resin, and the like). The refractive index distribution of the isotropic film is not strictly limited to the relationship: nx=ny=nz. The difference in refractive index among the three is small enough not to practically have adverse influences on display qualities of the liquid crystal display device. Specifically, each of a retardation Re [590] in the in-plane direction and a retardation Rth [590] in the thickness direction is preferably 10 nm or less, and more preferably 8 nm or less, and still more preferably 5 nm or less, at a wavelength of 590 nm.

The above-mentioned Re is represented by the following formula (1):

Re=(nx−ny)×d (1)

where nx, ny, and nz are the same as those mentioned above, and d is a thickness of the film.

The above-mentioned Rth is represented by the following formula (2):

Rth={(nx+ny)/2−nz}×d (2)

where nx, ny, nz, and d are the same as those mentioned above.

FIG. 3 is a schematic view showing, in a configuration where an isotropic film 16a is used as the first protective film 16 in accordance with Embodiment 1, an absorption axis a and a transmission axis t of the back polarizer 9b, an axis angle of a refraction index distribution of the isotropic film 16a, an arrangement relationship between a transmission axis T and a reflective axis R of the reflection and polarization sheet 4, when the observation direction is a direction of light propagation. FIG. 3(a) shows those when an incident direction of light is the front direction (front view). FIG. 3(b) shows those when an incident direction of light is a direction with an angle half of an angle made by the absorption axis a and the transmission axis t of the back polarizer 9b with respect to the front direction (oblique view).

Light that has entered the reflection and polarization sheet 4 from the light source 1 is converted into linearly-polarized light by the reflection and polarization sheet 4. The isotropic film 16a has no refractive index difference even when viewed in an oblique direction, as shown in FIG. 3(b). The transmission axis t of the back polarizer 9b is also parallel to an axis p of every principal refractive index of the isotropic film 16a, and the linearly-polarized light passes through the isotropic film 16a without change of its polarization state. So the component that passes through the back polarizer 9b that just follows the film 16a is not reduced. As a result, the transmittance in the oblique direction is not decreased, and so the white luminance in the oblique direction is not reduced.

### Use of Positive A-Plate

FIG. 4 is a schematic view showing a refractive index distribution of a positive A-plate.

As shown in FIG. 4, the positive A-plate is a film satisfying a condition of nx>ny=nz, with two principal refractive indexes in the in-plane direction being nx, ny, one principal refractive index in the normal direction being nz, of three principal refractive indexes of a indicatrix. The positive A-plate can be prepared from a material that can exhibit a retardation by being stretched and thereby increasing its refractive index in the stretching direction (for example, polycarbonate, polyethylenenaphthalate, polyethylene terephthalate, and norbornene resin) by casting, melt extrusion, and the like. In this case, the stretching direction is a phase delay axis direction of the positive A-plate.

It is preferable that the positive A-plate is stretched by longitudinal uniaxial stretching, horizontal uniaxial stretching, and the like. The polarizer is typically produced in the following procedures. A PVA film is stained by being impregnated with a solution containing a dichroic material such as iodine and then stretched in the longitudinal direction with being impregnated with a solution containing a boron compound and the like. According to the polarizer, the PVA molecules are aligned in the stretching direction, and this stretching direction is coincident with an absorption axis-direction of the polarizer. Thus, the longitudinal direction of the production line (direction where the production line proceeds) corresponds with the absorption axis-direction. From view point of durability of the back polarizer, it is preferable that the positive A-plate is attached to the back polarizer with an adhesive material therebetween by roll-to-roll process, and so, the longitudinal uniaxial stretching is most preferable because it allows that the absorption axis of the polarizer is parallel to the phase delay axis of the positive A-plate.

Of the three principal refractive indexes, ny and nz may not be necessarily strictly satisfy the relationship of ny=nz. The difference in refractive index between the two is small enough not to practically have adverse influences on display qualities of the liquid crystal display device. Specifically, a retardation. Ryz [590] is preferably 10 nm or less, and more preferably 8 nm or less, and still more preferably 5 nm or less, at a wavelength of 590 nm.

The Ryz is represented by the formula (3):

Ryz=(ny−nz)×d (3)

where ny and nz are the same as those mentioned above.

FIG. 5 is a schematic view showing, in a configuration where a positive-A plate 16b that is attached to the back polarizer 9b in such a way that a phase delay axis s of the positive A-plate 16b is parallel to an absorption axis a of the back polarizer 9b is used as the first protective film (protective film for protecting the back face of the back polarizer) 16 in accordance with Embodiment 1, a transmission axis T and a reflective axis R of the reflection and polarization sheet 4, an axis angle of a refractive index distribution of the positive A-plate 16b, and an arrangement relationship between an absorption axis a and a transmission axis t of the back polarizer 9b, when the observation direction is a direction of light propagation. FIG. 5(a) shows those when an incident direction of light is the front direction (front view). FIG. 5(b) shows those when an incident direction of light is a direction with an angle half of an angle made by the absorption axis a and the transmission axis t of the back polarizer 9b with respect to the front direction (oblique view).

Light that has entered the reflection and polarization sheet 4 from the light source 1 is converted into linearly-polarized light by the reflection and polarization sheet 4. In this case, when viewed in an oblique direction, the positive A-plate 16b has a refractive index distribution shown in FIG. 5(b). If the positive A-plate 16b is arranged in such a way that its phase delay axis s is parallel to the absorption axis a of the back polarizer 9b, the transmission axis t of the back polarizer 9b is parallel to a phase advance axis f of the positive A-plate 16b regardless of the observation direction. So the component that passes through the back polarizer 9b that just follows the film 16b is not reduced. As a result, the transmittance in the oblique direction is not decreased, and therefore the white luminance in the oblique direction is not reduced.

FIG. 6 is a schematic view showing, in a configuration where the positive A-plate 16b that is attached to the back polarizer 9b in such a way that a phase delay axis s of the positive A-plate 16b is perpendicular to the absorption axis a of the back polarizer 9b is used as the first protective film (protective film for protecting the back face of the back polarizer) 16 in accordance with Comparative Embodiment, a transmission axis T and a reflective axis R of the reflection and polarization sheet 4, an axis angle of a refractive index distribution of the positive A-plate 16b, and an arrangement relationship between an absorption axis a and a transmission axis t of the back polarizer 9b, when the observation direction is a direction of light propagation. FIG. 6(a) shows those when an incident direction of light is the front direction (front view). FIG. 6(b) shows those when an incident direction of light is a direction with an angle half of an angle made by the absorption axis a and the transmission axis t of the back polarizer 9b with respect to the front direction (oblique view).

In this case, when viewed in an oblique direction, the positive A-plate 16b has a refractive index distribution shown in FIG. 6(b). If the positive A-plate 16b is arranged in such a way that its phase delay axis s is perpendicular to the absorption axis a of the back polarizer 9b, the transmission axis t of the back polarizer 9b is not parallel to every axis (phase advance axis f and phase delay axis s) of principal refractive indexes of the positive A-plate 16b. As a result, the linearly-polarized light is converted into an elliptical polarized light. Accordingly, in the oblique direction, a component that passes through the back polarizer 9b is decreased. That is, the transmittance in the oblique direction is decreased, and so, the white luminance in the oblique direction is reduced. Thus, it is not preferable that the positive A-plate 16b is arranged in such a way that its phase delay axis s is perpendicular to the absorption axis a of the back polarizer 9b.

### Use of Negative A-Plate

FIG. 7 is a schematic view showing a refractive index distribution of a negative A-plate.

As shown in FIG. 7, the negative A-plate is a film satisfying a condition of nx<ny=nz, with two principal refractive indexes in the in-plane direction being nx, ny, one principal refractive index in the normal direction being nz, of three principal refractive indexes of a indicatrix. The negative A-plate can be prepared from a material that can exhibit a retardation by being stretched and thereby increasing its refractive index in the direction perpendicular to the stretching direction (for example, a styrene resin, an N-phenyl-substituted maleimide resin) by casting, melt extrusion, and the like. In this case, the stretching direction is a phase advance axis direction of the negative A-plate. Longitudinal uniaxial stretching is most preferably employed for stretching the negative A-plate for the same reason as mentioned in the positive A-plate.

Of the three principal refractive indexes, ny and nz may not be necessarily strictly satisfy the relationship of ny=nz. The difference in refractive index between the two is small enough not to practically have adverse influences on display qualities of the liquid crystal display device. Specifically, a retardation Ryz [590] is preferably 10 nm or less, and more preferably 8 nm or less, and still more preferably 5 nm or less at a wavelength of 590 nm. The Ryz is represented by the formula (3).

FIG. 8 is a schematic view showing, in a configuration where a negative A-plate 16c that is attached to the back polarizer 9b in such a way that a phase advance axis s of the negative A-plate 16c is parallel to an absorption axis a of the back polarizer 9b is used as the first protective film (protective film for protecting the back face of the back polarizer) 16 in accordance with Embodiment 1, a transmission axis T and a reflective axis R of the reflection and polarization sheet 4, an axis angle of a refractive index distribution of the negative A-plate 16c, and an arrangement relationship between an absorption axis a and a transmission axis t of the back polarizer 9b, when the observation direction is a direction of light propagation. FIG. 8(b) shows those when an incident direction of light is the front direction (front view). FIG. 8(b) shows those when an incident direction of light is a direction with an angle half of an angle made by the absorption axis a and the transmission axis t of the back polarizer 9b with respect to the front direction (oblique view).

Light that has entered the reflection and polarization sheet 4 from the light source 1 is converted into linearly-polarized light by the reflection and polarization sheet 4. The negative A-plate 16c has a refractive index distribution shown in FIG. 8(b) when viewed in an oblique direction. If the negative A-plate 16c is arranged in such a way that its phase advance axis f is parallel to the absorption axis a of the back polarizer 9b, the transmission axis t of the back polarizer 9b is parallel to the phase delay axis s of the negative A-plate 16c regardless of the observation direction, and the linearly-polarized light passes through the negative A-plate 16c without change of its polarization state. So the component that passes through the back polarizer 9b that just follows the film 16c is not reduced. As a result, the transmittance in the oblique direction is not decreased, and therefore the white luminance in the oblique direction is not reduced.

FIG. 9 is a schematic view showing, in a configuration where the negative A-plate 16c that is attached to the back polarizer 9b in such a way that a phase advance axis s of the negative A-plate 16c is perpendicular to the absorption axis a of the back polarizer 9b is used as the first protective film (protective film that protects a back face of the back polarizer) 16 in accordance with Comparative Embodiment, a transmission axis T and a reflection axis R of the reflection and polarization sheet 4, an axis angle of a refractive index distribution of the negative A-plate 16c, and an arrangement relationship between an absorption axis a and a transmission axis t of the back polarizer 9b, when the observation direction is a direction of light propagation. FIG. 9(a) shows those when an incident direction of light is the front direction (front view). FIG. 9(b) shows those when an incident direction of light is a direction with an angle half of an angle made by the absorption axis a and the transmission axis t of the back polarizer 9b with respect to the front direction (oblique view).

In this case, the negative A-plate 16c has a refractive index distribution shown in FIG. 9, when viewed in an oblique direction. If the negative A-plate 16c is arranged in such a way that its phase advance axis f is perpendicular to the absorption axis a of the back polarizer 9b, the transmission axis t of the back polarizer 9b is not parallel to every axis (phase advance axis f and phase delay axis s) of principal refractive indexes of the negative A-plate 16c when viewed in the oblique direction. As a result, the linearly-polarized light is converted into an elliptical polarized light. Accordingly, in the oblique direction, a component that passes through the back polarizer 9b is decreased. That is, the transmittance in the oblique direction is decreased, and so, the white luminance in the oblique direction is reduced. Thus, it is not preferable that the negative A-plate 16c is arranged in such a way that its phase delay axis s is perpendicular to the absorption axis a of the back polarizer 9b.

### Example 1

### Production of Isotropic Film

In a pressure-resistant reactor the inside of which was dried and substituted with nitrogen, tetrahydrofuran 500 ml as a solvent, and sec-butyllithium 0.58 mmol as a polarization catalyst, were added. Then, 2-vinyl naphthalene 30 g was added thereto, and a polymerization reaction was allowed to proceed at 30° C. for 2 hours. After completion of the polymerization reaction, the polymerization liquid 1 ml was sampled and charged into a large amount of methanol. As a result, poly(2-vinylnaphthalene) was obtained.

Then, to the pressure-resistant reactor, isoprene 1.58 g was added after the polarization reaction, and a polymerization reaction was allowed to proceed at 30° C. for 2 hours. As a result, a 2-vinylnaphthalene-isoprene block copolymer was obtained. Then, to the pressure-resistant reactor, dibromo butane 0.1 g was added and a coupling reaction was allowed to proceed at 30° C. for 3 hours. Into the polymerization liquid, a larger amount of methanol was charged, and the copolymer was settled and thereby obtained. The obtained copolymer was dissolved in cyclohexane 500 ml, and thereinto Pd—C (Pd 5%) 1.58 g was added as a hydrogen-adding catalyst, and a hydrogen-adding reaction of an isoprene residue unit was allowed to proceed for 3 hours at a hydrogenation pressure of 20 kg/cm² and at a reaction temperature of 150° C. After the reaction, the catalyst was removed by filtration to obtain a hydrogen-added block copolymer.

The hydrogen-added block copolymer obtained in the above-procedures was fed into a T-die extruder, and melt-extruded onto a chill roll at a melting temperature of 275° C. and at a take-up speed of 15 m/min, thereby preparing an isotropic film. The obtained isotropic film was measured for retardation by an automatic birefringence meter (trade name: KOBRA-21ADH, product of Oji Scientic Instruments). The film had a Re of 5 nm and a Rth of 4 nm.

Polarization plates were separated from a commercially available liquid crystal TV (trade name: LC-32AD5, product of Sharp Corp.) and disassembled into layers, and each layer was analyzed. In the polarization plate on the observation side, protective films on both sides of a polarizer were TAC films. In the polarization plate on the backlight side, a protective film on the liquid crystal cell side of a polarizer was a retardation film formed from a norbornene resin, and a protective film on the other side was a TAC film. The retardation film that is formed from a norbornene resin was measured for retardation by an automatic birefringence meter (trade name: KOBRA-21ADH, product of Oji Scientic Instruments). The retardation film had a Re of 65 nm and a Rth of 220 nm.

Of the polarization plates that had been separated from both sides of a liquid crystal display panel of the TV, the polarization plate on the backlight side was attached to a front side-surface (observation side-surface) of a liquid crystal cell in such a way that the retardation film formed from a norbornene resin was positioned on the liquid crystal cell side and that the TAC film was positioned on the observation side. Further, the polarization plate on the observation side was separated into the polarizer and the TAC film with a knife to give a polarization plate having a TAC film on one side thereof (hereinafter, also referred to as a “one-TAC film-including polarization plate”), and this polarization plate was attached to a back side-surface (backlight side-surface) of the liquid crystal cell with a cohesive layer between the TAC film and the liquid crystal cell. In the present Example, the above-prepared isotropic film was attached, as the first protective film, to a back face of the back polarizer with a cohesive material therebetween.

### Example 2

### Production of Positive A-Plate

A norbornene resin that is an amorphous thermoplastic resin (trade name: ZEONOR, product of ZEON CORPORATION) was fed into a T-die extruder, and melt-extruded onto a chill roll at a melting temperature of 230° C. and at a take-up speed of 20 m/min to prepare a Zeonor film. This film was uniaxially stretched through zones of a preliminary heating temperature of 100° C., a stretching temperature of 161° C., and a cooling temperature of 100° C. with a roll longitudinal uniaxial stretching apparatus. Thus-obtained A-plate had a retardation Re of 100 nm and a retardation Rth of 50 nm. The prepared A-plate was attached, as the first protective film, to the one-TAC-including polarization plate (the back face of the back polarizer) produced in the same manner as in Embodiment 1, with a cohesive material therebetween, in such a way that a phase delay axis of the A-plate was parallel to an absorption axis of the back polarizer.

### Comparative Example 1

To the one-TAC-including polarization plate (the back face of the back polarizer) produced in the same manner as in Example 1, a TAC film (trade name: FUJITAC, product of FUJIFILM Corp.) was attached, as the first protective film (protective film), with a cohesive material therebetween. The TAC film was measured for retardation by an automatic birefringence meter (trade name: KOBRA-21ADH, product of Oji Scientic Instruments). The TAC film had a Re of 2 nm and a Rth of 60 nm.

### Evaluation Results

The liquid crystal display devices produced in Examples 1 and 2 and Comparative Example 1 were measured for white luminance with a viewing angle measurement device (trade name: EZContrast 160R, product of ELDIM Company). The three devices were measured for a white luminance in the case that a reflection and polarization sheet (trade name: DBEF-D, product of Sumitomo 3M Limited) which a backlight system of a liquid crystal TV (trade name: LC-32AD5, product of Sharp Corp.) included was used and that in the case that the sheet was not used. An improvement rate of the white luminance was determined. Further, the improvement rate was compared between the case that the backlight system included one diffusion sheet and the case that it included two diffusion sheets. The diffusion sheet collects light by lens effect attributed to its surface roughness. So the number of the sheet is adjusted to increase an amount of light emitted in the front direction. The improvement rate of the white luminance was determined based on the following formula (3). The following Table 1 shows the results of the case where the backlight system included one diffusion sheet. The following Table 2 shows the results of the case where the backlight system included two diffusion sheets. In Tables 1 and 2, Θ and Φ represent a polar angle and an azimuth angle, respectively. The polar angle is an angle made by an observation face and an observation direction. With respect to the azimuth angle, when the display face of the liquid crystal display device is viewed in front, the 3 o'clock direction is 0°; the 12 o'clock direction is 90°; the 9 o'clock direction is 180°; and the 6 o'clock direction is 270°.

(Improvement rate in white luminance)=(white luminance when “DBEF-D” is arranged)/(white luminance when “DBEF-D” is not arranged) (3)

TABLE 1

| | Front | Θ = 40° | | |
|---|---|---|---|---|
| | direction | Φ = 0° | Φ = 45° | Φ = 90° |
| Example 1 | 1.491 | 1.774 | 1.688 | 1.587 |
| Example 2 | 1.494 | 1.772 | 1.686 | 1.584 |
| Comparative | 1.487 | 1.769 | 1.6 | 1.574 |
| Example 1 | | | | |

TABLE 2

| | Front | Θ = 40° | | |
|---|---|---|---|---|
| | direction | Φ = 0° | Φ = 45° | Φ = 90° |
| Example 1 | 1.438 | 1.861 | 1.773 | 1.685 |
| Example 2 | 1.456 | 1.889 | 1.809 | 1.706 |
| Comparative | 1.407 | 1.818 | 1.769 | 1.634 |
| Example 1 | | | | |

The comparison between Examples 1 and 2, and Comparative Example 1 shows that the improvement rate in white luminance in the front direction and that in the oblique directions are improved. This shows the followings. When the backlight system including the “DBEF-D” was used, linearly-polarized light obtained by the “DBEF-D” enters the back polarizer in the direction parallel to the transmission axis of the back polarizer, without being converted by the protective film by arranging the protective film that protects the back face of the back polarizer, i.e., the isotropic film, or the positive or negative A-plate, in such a way that its optic axis was parallel to the absorption axis of the back polarizer. As a result, the white luminance was improved compared with Comparative Example 1 where the TAC film was used as the protective film. Thus, the advantages of the present invention were obtained in Examples 1 and 2.

According to the above Embodiments and Examples, the case where the reflection and polarization sheet is a member of the backlight system is described. However, the reflection and polarization sheet is not necessarily a member of the backlight system. It may be a member of the polarizer, and may be attached to the protective film (a second protective film) that protects the back face of the back polarizer with a cohesive material therebetween.

The present application claims priority to Patent Application No. 2007-492543 filed in Japan on Jul. 24, 2007 under the Paris Convention and provisions of national law in a designated State, the entire contents of which are hereby incorporated by reference.

### BRIEF DESCRIPTION OF DRAWINGS

FIG. 1 is a cross-sectional view schematically showing a configuration of a liquid crystal display device in accordance with Embodiment 1.

FIG. 2 is a schematic view showing a refractive index distribution of an isotropic film.

FIG. 3 is a schematic view showing, in a configuration where an isotropic film is used as the first protective film in accordance with Embodiment 1, a transmission axis and a reflective axis of a reflection and polarization sheet, an axis angle of a refractive index distribution of an isotropic film, and an arrangement relationship between an absorption axis and a transmission axis of a back polarizer, when the observation direction is a direction of light propagation.

FIG. 3(a) shows those when an incident direction of light is the front direction (front view).

FIG. 3(b) shows those when an incident direction of light is a direction with an angle half of an angle made by the absorption axis and the transmission axis of the back polarizer with respect to the front direction (oblique view).

FIG. 4 is a schematic view showing a refractive index distribution of a positive A-plate.

FIG. 5 is a schematic view showing, in a configuration where a positive A-plate that is attached to a back polarizer so that its phase delay axis is parallel to an absorption axis of the back polarizer is used as the first protective film in accordance with Embodiment 1, a transmission axis and a reflective axis of a reflection and polarization sheet, an axis angle of a refractive index distribution of the positive A-plate, and an arrangement relationship between an absorption axis and a transmission axis of the back polarizer, when the observation direction is a direction of light propagation.

FIG. 5(a) shows those when an incident direction of light is the front direction (front view).

FIG. 5(b) shows those when an incident direction of light is a direction with an angle half of an angle made by the absorption axis and the transmission axis of the back polarizer with respect to the front direction (oblique view).

FIG. 6 is a schematic view showing, in a configuration where the positive A-plate that is attached to the back polarizer in such a way that its phase delay axis is perpendicular to the absorption axis of the back polarizer is used as the first protective film in accordance with Comparative Embodiment, a transmission axis and a reflective axis of a reflection and polarization sheet, an axis angle of a refractive index distribution of the positive A-plate, and an arrangement relationship between an absorption axis and a transmission axis of the back polarizer, when the observation direction is a direction of light propagation.

FIG. 6(a) shows those when an incident direction of light is the front direction (front view).

FIG. 6(b) shows those when an incident direction of light is a direction with an angle half of an angle made by the absorption axis and the transmission axis of the back polarizer with respect to the front direction (oblique view).

FIG. 7 is a schematic view showing a refractive index distribution of a negative A-plate.

FIG. 8 is a schematic view showing, in a configuration where the negative A-plate that is attached to the back polarizer in such a way that its phase advance axis is parallel to an absorption axis of the back polarizer is used as the first protective film in accordance with Embodiment 1, a transmission axis and a reflective axis of the reflection and polarization sheet, an axis angle of a refractive index distribution of the negative A-plate, and an arrangement relationship between an absorption axis and a transmission axis of the back polarizer, when the observation direction is a direction of light propagation.

FIG. 8(a) shows those when an incident direction of light is the front direction (front view).

FIG. 8(b) shows those when an incident direction of light is a direction with an angle half of an angle made by the absorption axis and the transmission axis of the back polarizer with respect to the front direction (oblique view).

FIG. 9 is a schematic view showing, in a configuration where the negative A-plate that is attached to the back polarizer in such a way that its phase delay axis is perpendicular to the absorption axis of the back polarizer is used as the first protective film in accordance with Comparative Embodiment, a transmission axis and a reflective axis of the reflection and polarization sheet, an axis angle of a refractive index distribution of the negative A-plate, and an arrangement relationship between an absorption axis and a transmission axis of the back polarizer, when the observation direction is a direction of light propagation.

FIG. 9(a) shows those when an incident direction of light is the front direction (front view).

FIG. 9(b) shows those when an incident direction of light is a direction with an angle half of an angle made by the absorption axis and the transmission axis of the back polarizer with respect to the front direction (oblique view).

FIG. 10 is a cross-sectional view schematically showing a typical configuration where a protective film is attached to a polarizer.

FIG. 11 is a cross-sectional view schematically showing a configuration of a conventional common liquid crystal display device.

FIG. 12 is a schematic view showing a refractive index distribution of a TAC film.

FIG. 13 is a schematic view showing, in a conventional configuration where a TAC film is used as the first protective film (protective film for protecting a back face of a back polarizer), a transmission axis and a reflective axis of a reflection and polarization sheet, an axis angle of a refractive index distribution of the TAC film, and an arrangement relationship of an absorption axis and a transmission axis of the back polarizer, when the observation direction is a direction of light propagation.

FIG. 13(a) shows those when an incident direction of light is the front direction (front view).

FIG. 13(b) shows those when an incident direction of light is a direction with an angle half of an angle made by the absorption axis and the transmission axis of the back polarizer with respect to the front direction.

FIGS. 14(a) and 14(b) are schematic views showing a way of obtaining linearly-polarized light from non-polarized light using a reflection and polarization sheet.

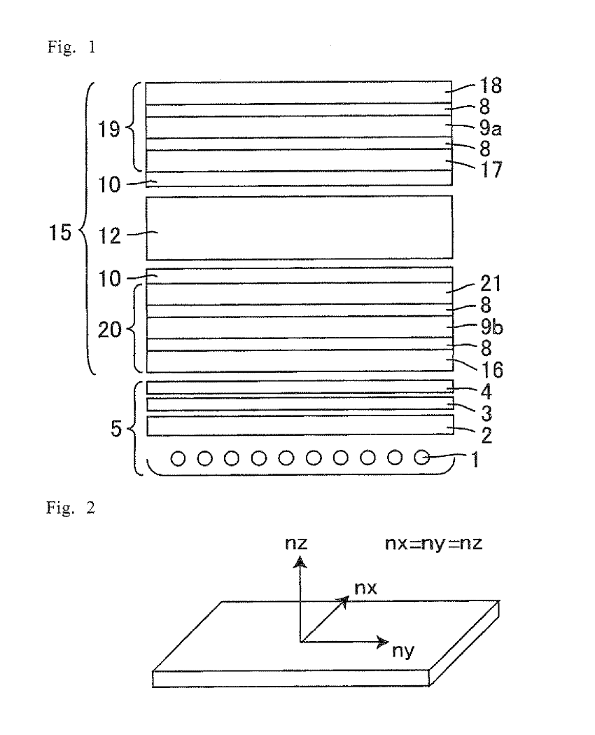

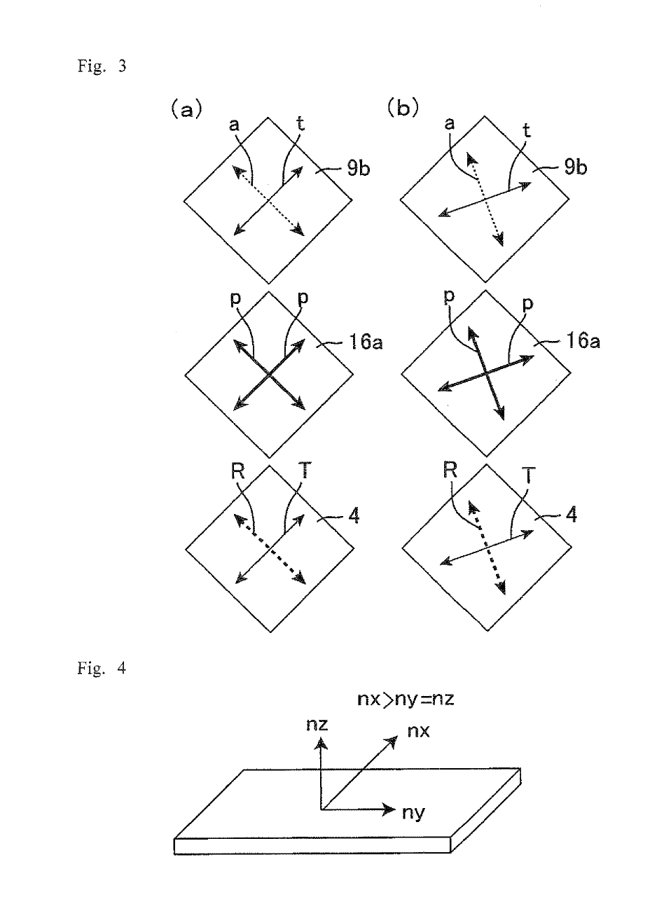

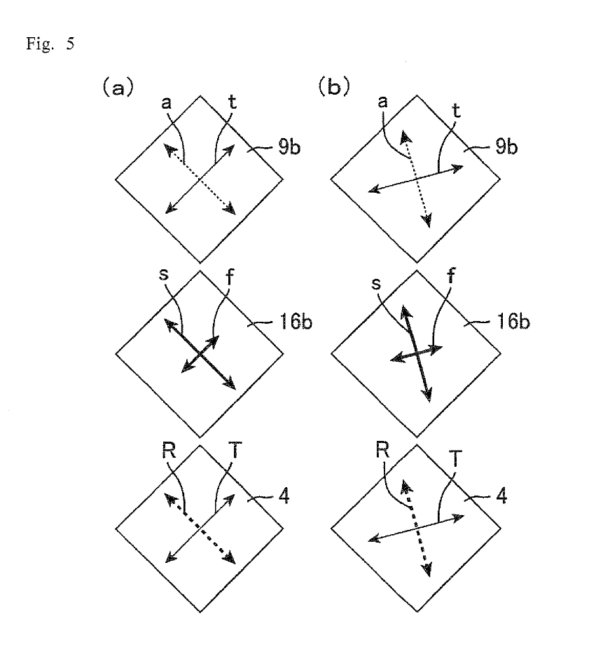

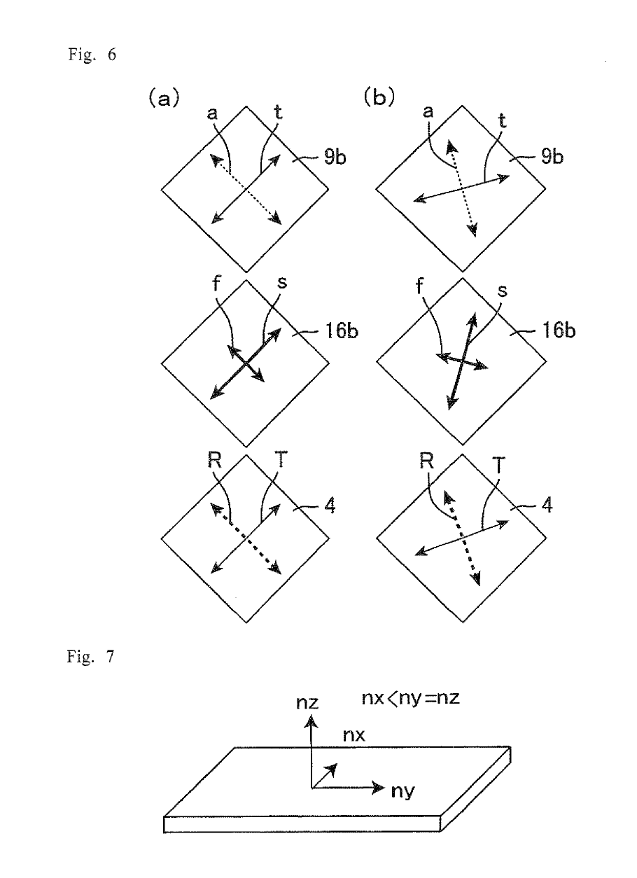

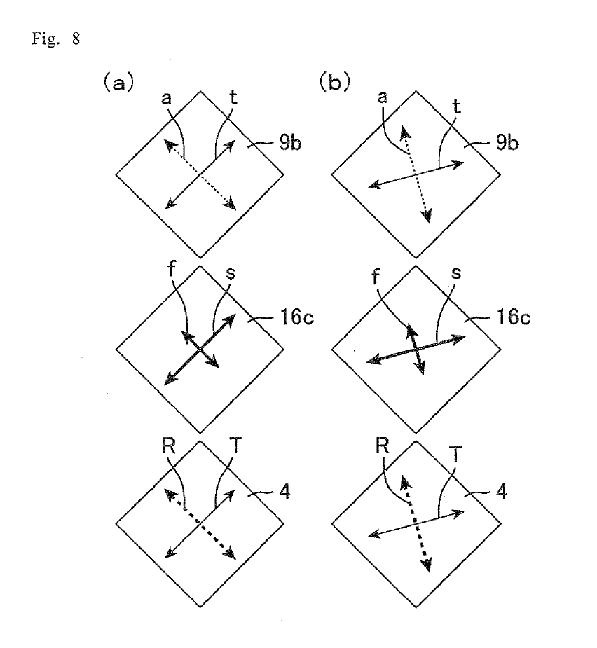

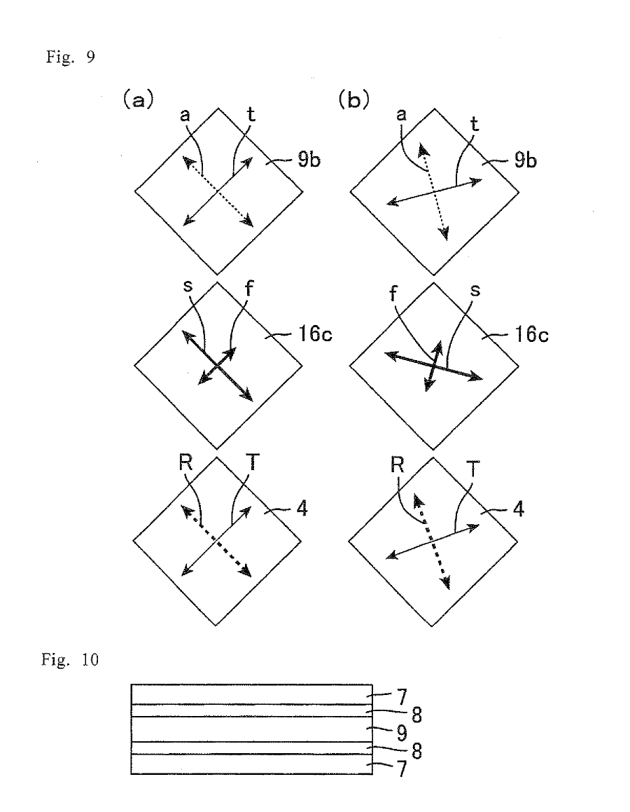

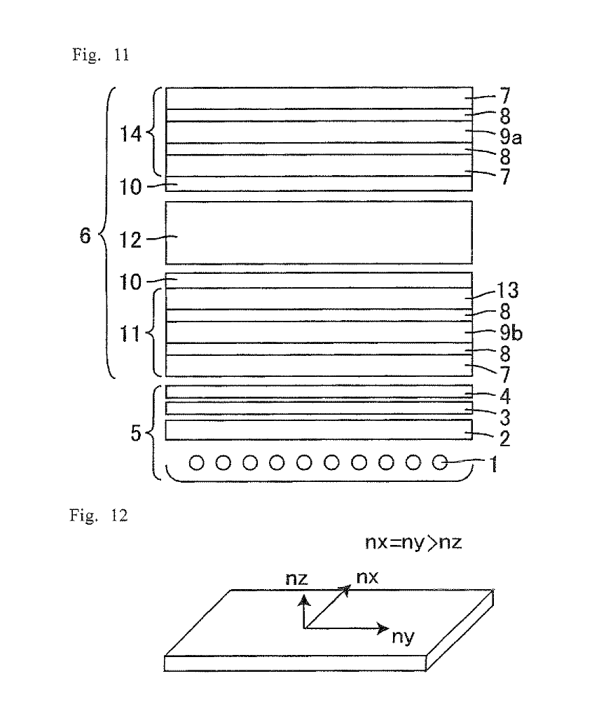

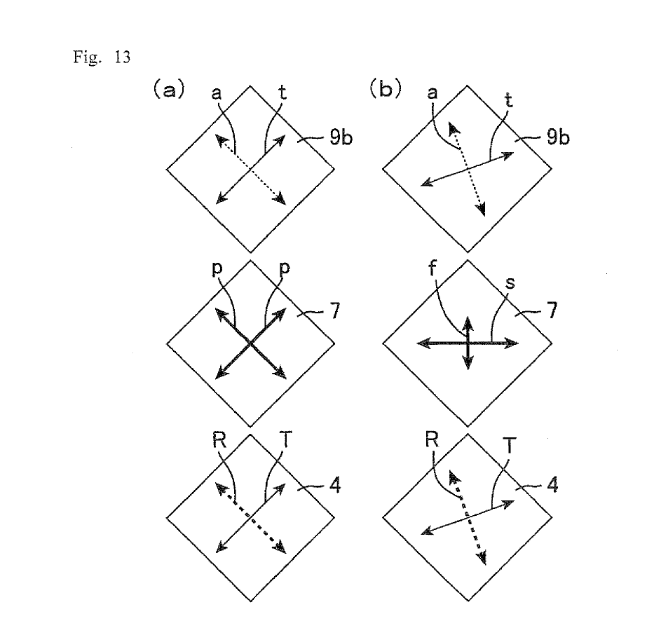

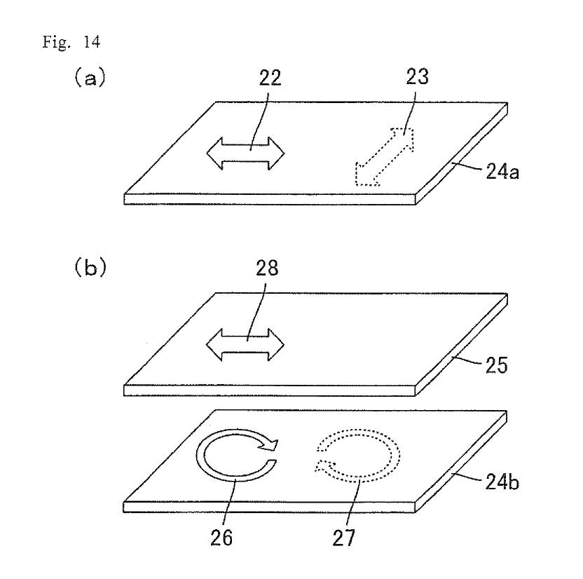

### EXPLANATION OF NUMERALS AND SYMBOLS

1: Cold cathode fluorescent lamp (light source)
2: Diffusion plate
3: Diffusion sheet
4, 24a, 24b: Reflection and polarization sheet
5: Backlight system
6, 15: Liquid crystal display panel
7: Negative C-plate (TAC film)
8: Adhesive layer
9: Polarizer
9a: Front polarizer
9b: Back polarizer
10: Cohesive layer
11, 20: Back polarization plate
12: Liquid crystal cell
13: Retardation film
14, 19: Front polarization plate
15: Liquid crystal display panel
16: First protective film (protective film, protective film for protecting a back face of a back polarizer)
16a: isotropic film
16b: Positive A-plate
16c: Negative A-plate
17: Third protective film (protective film for protecting a back face of a front polarizer)
18: Fourth protective film (protective film for protecting a front face of a front polarizer)
21: Second protective film (protective film for protecting a front face of a back polarizer)
22: Linearly-polarized light component that passes through a reflection and polarization sheet 24a
23: Linearly-polarized light component that is reflected by the reflection and polarization sheet 24a
25: ¼ wavelength plate
26: Right-handed circularly-polarized light component that passes through a reflection and polarization sheet 24b
27: Left-handed circularly-polarized light component that is reflected by the reflection and polarization sheet 24b
28: Linearly-polarized light
a: Absorption axis of back polarizer
t: Transmission axis of back polarizer
s: Phase delay axis of protective film
f: Phase advance axis of protective film
p: Axis of principal refractive index of protective film
T: Transmission axis of reflection and polarization sheet
R: Reflection axis of reflection and polarization sheet

1. A liquid crystal display device comprising:
a backlight system including a reflection and polarization sheet;
a back polarizer;
a liquid crystal cell; and
a front polarizer, stacked in this order,
wherein the liquid crystal display device includes a protective film that protects a back face of the back polarizer,
the protective film has no retardation in a thickness direction thereof, and
when the protective film is viewed in plane,
an optic axis of the protective film in an in-plane direction thereof is parallel to an absorption axis of the back polarizer.

2. The liquid crystal display device according to claim 1,
wherein the protective film is an optical film that shows optical isotropy.

3. The liquid crystal display device according to claim 1,
wherein the protective film is an optical film that has a retardation in the in-plane direction thereof and shows optically positive uniaxial, and
when the protective film is viewed in plane,
a phase delay axis of the protective film in the in-plane direction thereof is parallel to the absorption axis of the back polarizer.

4. The liquid crystal display device according to claim 1,
wherein the protective film is an optical film that has a retardation in the in-plane direction thereof and shows optically negative uniaxial, and
when the protective film is viewed in plane,
a phase advance axis of the protective film in the in-plane direction thereof is parallel to the absorption axis of the back polarizer.

5. A polarization plate comprising:
a reflection and polarization sheet;
a first protective film;
a polarizer; and
a second protective film, stacked in this order,
wherein the first protective film has no retardation in a thickness direction thereof, and
when the first protective film is viewed in plane,
an optic axis of the first protective film in the in-plane direction thereof is parallel to an absorption axis of the polarizer.

6. The polarization plate according to claim 5,
wherein the first protective film is an optical film that shows optical isotropy.

7. The polarization plate according to claim 5,
wherein the first protective film is an optical film that has a retardation in the in-plane direction thereof and shows optically positive uniaxial, and
when the first protective film is viewed in plane,
a phase delay axis of the protective film in the in-plane direction thereof is parallel to the absorption axis of the polarizer.

8. The polarization plate according to claim 5,
wherein the first protective film is an optical film that has a retardation in the in-plane direction thereof and shows optically negative uniaxial, and
when the first protective film is viewed in plane,
a phase advance axis of the protective film in the in-plane direction thereof is parallel to the absorption axis of the polarizer.

9. A liquid crystal display device comprising:
a backlight system;
the polarization plate according to claim 5;
a liquid crystal cell; and
a front polarizer, stacked in this order,
wherein the reflection and polarization sheet is arranged on a side of the backlight system, and
the second protective film is arranged on a side of the liquid crystal cell.
